(19) United States
(12) Patent Application Publication
(10) Pub. No.: US 2018/0272722 A1
(43) Pub. Date: Sep. 27, 2018

(54) Ink Tanks

(71) Applicants: Bryan MURPHY, Leixlip Co. Kildare (IE); Aidan O'REILLY, Leixlip Co. Kildare (IE); Coilin HEGARTY, Leixlip Co. Kildare (IE); John OLIVER, Leixlip Co. Kildare (IE); Hewlett-Packard Development Company, L.P., Houston, TX (US)

(72) Inventors: Bryan Murphy, Leixlip Co. Kildare (IE); Aidan O'Reilly, Lexlip Co. Kildare (IE); Coilin Hegarty, Lexlip Co. Kildare (IE); John Oliver, Leixlip, Co Kildare (IE)

(21) Appl. No.: 15/523,663

(22) PCT Filed: Apr. 21, 2015
(86) PCT No.: PCT/EP2015/058567

§ 371 Date: May 1, 2017

(51) Int. Cl. B41J 2/175

(52) U.S. Cl. CPC B41J 2/17506; B41J 2/17556; B41J 2/17553

(57) ABSTRACT

An ink tank for an inkjet printer is described. The ink tank has a top end and a bottom end and includes an ink conduit connecting the inside of the tank to the outside and extending inside the tank from the top end by a first distance; an air conduit connecting the inside of the tank to the outside and extending inside the tank from the top end by a second distance, the second distance being less than the first distance; a vent connecting the inside of the tank to the outside, an inside opening of the vent being located at a third distance, less than the second distance, from the top end; and an ink outlet connecting the inside of the tank to the outside, an inside opening of the ink outlet being located at a fourth distance, greater than the second distance, from the top end.

### BACKGROUND

“Off-axis” ink jet printers have been developed which have small, moving print heads that are connected to large stationary ink reservoirs (tanks) by flexible ink tubes. Separating the ink reservoir from the print head allows the ink to be replaced without requiring simultaneous replacement of the print head.

### BRIEF DESCRIPTION OF DRAWINGS

Examples will now be described, by way of non-limiting examples, with reference to the accompanying drawings, in which:

FIG. 1 is a simplified schematic of an example of an ink tank for an inkjet printer;

FIG. 2 shows an example of an ink tank for an inkjet printer;

FIG. 3 shows an example of a refill bottle;

FIGS. 4a and 4b show an example of a refill bottle engaged with an example of an ink tank;

FIG. 5 is a simplified schematic of an example of a refill bottle engaged with an example of an ink tank during an example of a refilling operation; and

FIG. 6 is a flowchart of an example of a method of refilling an ink tank of a printer.

### DETAILED DESCRIPTION

In an effort to reduce the cost and size of ink-jet printers and to reduce the cost per printed page, engineers have developed “off-axis” ink-jet printers having small, moving print heads that are connected to large stationary ink tanks by flexible ink tubes. In such printers the mass of the print head is small so that the cost of the print head drive system and the overall size of the printer can be minimized. In addition, separating the ink tank from the print head allows the ink to be replaced without simultaneously costly print heads.

Ink replacement in off-axis printers can be achieved by the user purchasing a refill bottle of ink and pouring the contents into the ink tank on the printer. However; this procedure risks the user spilling ink onto their clothing or belongings, and/or overfilling the ink tank so that it overflows.

An ink tank for an inkjet printer may comprise, for example, an interface to engage with a refill bottle such that when the refill bottle is engaged with the ink tank, ink is transferred from the refill bottle to the ink tank until the refill bottle is empty or until a maximum fill level of the ink tank is reached. The refill bottle may then be left engaged with the ink tank, e.g. if not all of the ink from the refill bottle has been transferred to the ink tank, or may be disengaged from the ink tank.

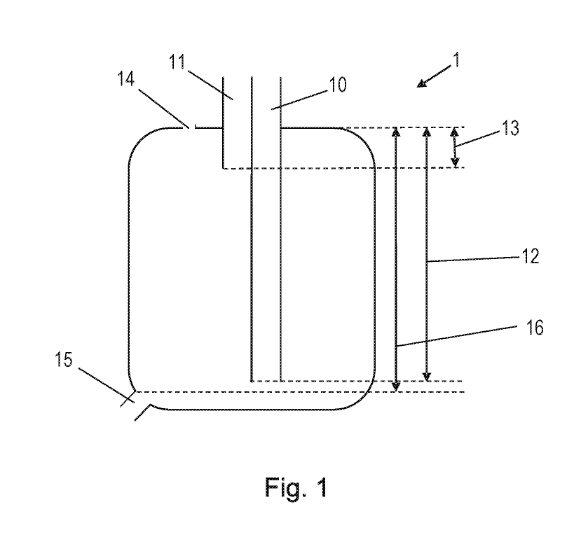

FIG. 1 shows an example of an ink tank 1 for an inkjet printer. The ink tank 1 has a top end and a bottom end. When the ink tank 1 is installed in or on a printer, the direction of gravity is from the top end to the bottom end, such that ink in a partially full tank rests at the bottom end of the tank. The ink tank 1 comprises an ink conduit 10, an air conduit 11, a vent 14, and an ink outlet 15. In some examples the ink tank is an “off-axis” ink tank, meaning that when it is installed in a printer it is located remotely from the print head. In some such examples, the ink tank 1 is to be located outside a main housing of a printer when installed on a printer. In some examples, details of the shape and configuration of the ink tank 1 are to fit or match with the configuration of a printer on which the ink tank 1 is to be installed. In some examples the ink tank 1 is to be used with an off-axis printer. In some examples the ink tank 1 is to be used with a printer designed to be supplied with ink at a negative pressure. In some such examples the ink tank 1 is to be used with a printer designed to be supplied with ink at a negative pressure that falls within a predetermined range.

The ink conduit 10 connects the inside of the tank to the outside of the tank. The ink conduit 10 extends inside the tank from the top end by a first distance 12. The ink conduit 10 provides a first flow path between the inside of the ink tank 1 and the outside of the ink tank 1. When a refill bottle is engaged with the ink tank 1 during a refilling operation, the ink conduit 10 provides a flow path via which ink may flow from the refill bottle to the ink tank 1. In some examples the ink conduit 10 comprises an enclosed channel having a length and a cross-sectional area. In some examples the ink conduit comprises a tube. In some examples the first distance 12 is almost equal to the height (i.e. the distance between a top wall and a bottom wall) of the ink tank 1. In some examples the length of the ink conduit 10 is greater than the first distance 12 such that the ink conduit 10 extends upwardly from a top wall of the ink tank 1.

The air conduit 11 connects the inside of the tank to the outside of the tank. The air conduit extends inside the tank from the top end by a second distance 13, where the second distance 13 is less than the first distance 12. The air conduit 11 provides a second flow path between the inside of the ink tank 1 and the outside of the ink tank 1. When a refill bottle is engaged with the ink tank 1 during a refilling operation, the air conduit 11 provides a flow path via which air (i.e. air displaced by the filling of the ink tank with ink) may flow from the ink tank 1 to the refill bottle.

In some examples the air conduit 11 comprises an enclosed channel having a length and a cross-sectional area. The cross-sectional area of the air conduit 11 governs the flow rate of ink from a refill bottle into the tank 1, because ink will flow as fast as air can enter the refill bottle to displace it. Entry of air into the refill bottle is governed by the bubble pressure at the top opening of the air conduit 11 (i.e. the opening which is inside the refill bottle during a refill operation). This bubble pressure is inversely proportional to the effective radius of the opening. In some examples the cross-sectional area of the air conduit 11 is sufficient that the hydrostatic head height of the column of liquid exceeds the bubble pressure. In some examples the cross-sectional area of the air conduit 11 is less than the cross-sectional area of the ink conduit 10.

In some examples the air conduit comprises a tube. In some examples the second distance 13 is significantly less than the first distance 12. In some examples the second distance 13 is less than half of the first distance 12. In some examples the second distance 13 is less than a quarter of the first distance 12. In some examples the length of the air conduit 11 is greater than the second distance 13 such that the air conduit 11 extends upwardly from a top wall of the ink tank 1.

In some examples the second distance 13 is selected to prevent an ink level in the ink tank when the ink tank is being filled via the ink conduit 10 from increasing above a predetermined maximum level. During a refilling operation of the ink tank 1, when the ink level in the tank reaches the bottom of the air conduit 11, air can no longer flow from the ink tank into the refill bottle and this prevents further ink from flowing out of the refill bottle into the ink tank. Thus the location of the bottom of the air conduit 11, which is at the second distance 13, sets a maximum fill level of the ink tank 1.

In some off-axis printing systems, the ink is supplied from the tank at a pressure which is lower than atmospheric pressure. This negative pressure, referred to as “back pressure”, prevents ink from leaking out of the print head. Thus, if the back pressure is too low, leakage of ink from the print head can occur. One way of creating back pressure is to locate the ink tank physically below the print head. In such arrangements the magnitude of the backpressure is determined by the height difference between the level of the ink within the tank and the location of the print head. The back pressure will therefore increase as the tank empties and decrease as the tank is filled. In such examples overfilling the tank can cause the back pressure to become too low, resulting in ink leaking out from the print head. Therefore, in some examples the second distance 13 is selected to prevent a backpressure in the ink tank when the ink tank is in use on an inkjet printer from decreasing below a predetermined minimum back pressure.

In some examples the ink conduit 10 and the air conduit 11 are separate. In other examples the ink conduit 10 and the air conduit 11 are adjacent to each other. In some such examples the ink conduit 10 and the air conduit 11 are integrally formed, e.g. as a tube with an internal partition along its length. In examples in which the ink conduit 10 and the air conduit 11 are integrally formed, these conduits are defined by a single, monolithic component, (i.e. rather than by a combination of multiple connected components). In some examples in which the ink conduit 10 and the air conduit 11 are adjacent and/or integrated, the ink conduit 10 and the air conduit 11 have complementary cross-sectional shapes. In some such examples the complementary cross-sectional shapes of the ink conduit 10 and the air conduit 11 are to create a regularly-shaped combined cross-section of the ink conduit 10 and the air conduit 11 (e.g. this can be achieved by cross-sections comprising two semi-circles, a circle and a crescent, two rectangles, etc.). In such examples the combined cross section may be, e.g., circular, oval, square, rectangular, triangular, or any other regular shape. Examples in which the ink conduit and air conduit are adjacent and/or integrated enable the ink tank 1 to interface with a refill bottle which has a single opening. Examples in which the combined cross-section of the ink conduit 10 and the air conduit 11 is regularly-shaped enable the ink tank 1 to interface with a refill bottle which has a single regularly-shaped opening. Refill bottles often have a circular opening.

The vent 14 connects the inside of the tank to the outside of the tank. An inside opening of the vent 14 is located at a third distance from the top end, where the third distance is less than the second distance 13. In the example shown in FIG. 1 the vent is located in a top wall of the tank, so the third distance is zero. In some examples the vent 14 is located at a position such that an inside opening of the vent 14 has the maximum possible distance from a bottom surface of the tank 1. In some examples the vent 14 comprises a hole, e.g. in a top wall or a side wall of the tank 1. In some such examples the cross-sectional area of the hole is significantly less than the cross-sectional area of the air conduit 11. The vent 14 allows a refill bottle to be engaged with the tank 1 without creating a build up of pressure in the refill bottle due to a piston effect. It also allows a refill bottle to be disengaged from the tank 1 without creating a negative pressure in the tank. The creation of such a negative pressure could cause a “burp” at a septum of the refill bottle, which could in turn cause a drip to be released as the bottle is removed.

The vent 14 is to allow air to flow into the ink tank 1 from the outside environment as the ink level in the tank drops during use on a printer. This prevents a vacuum being created in the ink tank 1. It also enables the printer to be operated with the ink conduit 10 and the air conduit 11 of the ink tank 1 sealed, e.g. by a cap or by a refill bottle which has been left engaged with the ink tank 1. Sealing the ink conduit 10 and the air conduit 11 reduces water vapor loss. Leaving a refill bottle engaged with the ink tank 1, at least until the refill bottle is empty, reduces (or even minimizes) the risk of drips or spillage when eventually removing the refill bottle. Avoiding the creation of a vacuum in the ink tank facilitates clean and easy disengagement of a refill bottle. Provision of a tank vent also enables a refill operation to be conducted simultaneously with a printing operation. Provision of a tank vent means that if a refill bottle becomes empty during a printing operation, ink can still be drawn out of the ink tank because air can flow in through the vent to replace it, and so the printing operation is not interrupted.

The ink outlet 15 connects the inside of the tank to the outside of the tank. An inside opening of the ink outlet 15 is located at a fourth distance 16 from the top end, where the fourth distance 16 is greater than the second distance 13. In some examples the fourth distance is significantly greater than the second distance 13. In some examples the fourth distance is greater than the first distance 12. Any ink below the level of the inside opening of the outlet 15 cannot be withdrawn from the tank 1 through the ink outlet 15, therefore in some examples the inside opening of the ink outlet 15 is provided in or very near a bottom surface of the tank 1. In some examples the ink outlet 15 comprises an opening in the wall of the tank 1. In some examples the ink outlet 15 comprises a tube extending from an opening in a wall of the tank 1, and an inside opening of the vent comprises the distal end of the tube, such that the opening in the wall is closer to a top surface of the tank than the distal end of the tube. In some examples in which the ink tank is an off-axis ink tank, the ink outlet 15 is to enable connection to a remote print head, e.g. via an ink delivery tube. In some such examples the ink outlet comprises a connector to connect to an ink delivery tube.

In some examples, e.g. examples in which the ink is supplied from the tank at a back pressure, the ink tank 1 further comprises a pressure control device (not shown). The pressure control device connects the inside of the tank to the outside of the tank. An inside opening of the pressure control device is located at a fifth distance from the top end of the tank, where the fifth distance is less than the first distance and greater than the second distance. In some examples the pressure control device is to allow air into the ink tank when the backpressure exceeds a predetermined value. In some examples the pressure control device is to allow air into the ink tank when the ink level in the tank drops below the level at which the pressure control device is located. In some such examples the fifth distance is selected to prevent a backpressure in the ink tank when the ink tank is in use on an inkjet printer from exceeding a predetermined maximum back pressure. In some examples the pressure control device comprises a bubbler.

In some examples the ink tank 1 is formed as a single component. In other examples the ink tank 1 comprises a plurality of separate components which are joined together during manufacture of the ink tank 1. In some examples the ink tank 1 is made of a plastics material. In some examples the ink tank 1 is made of several different plastics materials. In some examples the ink tank comprises a transparent material to facilitate determination of an amount of ink contained in the ink tank.

An ink tank 1 can be made, for example, by manufacturing a tank body out of a plastic material by blow molding, manufacturing a separate interface component out of a plastics material by injection molding, and joining the interface component to the tank body to form the complete ink tank 1. In some such examples the tank body comprises the ink outlet 15. In some examples the tank body comprises the vent 14. In some examples the vent 14 is formed by a connection between the tank body and the interface component. In some examples the interface component comprises the air conduit 11 and the ink conduit 10. In some examples the interface component comprises the vent 14.

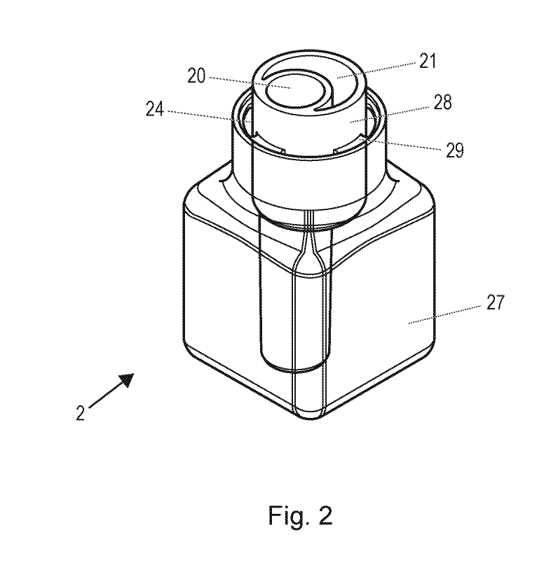

FIG. 2 shows an example of an ink tank 2 which comprises an interface component 28 joined to a tank body 27. The interface component 28 comprises an air conduit 21 formed integrally with an ink conduit 20. The cross-section of the ink conduit 20 comprises a circle and the cross-section of the air conduit 21 comprises a crescent which is complementary to the circular cross-section of the ink conduit, such that the combined cross-section of the ink conduit 20 and air conduit 21 is circular. In some examples the cross-sections of the air conduit 21 and ink conduit 20 are shapes other than a circle and a crescent, where the other shapes cooperate to create a circular combined cross-section. The interface component 28 further comprises seating ring 29 disposed around the outside surface of the combined ink/air conduit wall, and spaced from this wall by a small distance (e.g. a distance sufficient that the gap created can function as an air vent without permitting significant loss of water from the tank, where a significant loss of water is one which affects a property, e.g. concentration, of the ink). The seating ring 29 is joined to the combined ink/air conduit wall by a plurality of spokes. The gaps between the spokes create an air vent 24 when the interface component 28 is joined to the tank body 27.

The tank body 27 has a main reservoir portion and a neck extending upwardly from the top of the main reservoir portion. The neck has a circular cross-section, and the diameter of this circular cross-section is slightly larger than the diameter of the seating ring 29. In some examples the diameter of the neck cross-section and the diameter of the seating ring 29 are nearly equal so that the interface component 28 can be joined to the tank body 27 by means of an interference fit between the inner surface of the neck and the seating ring 29.

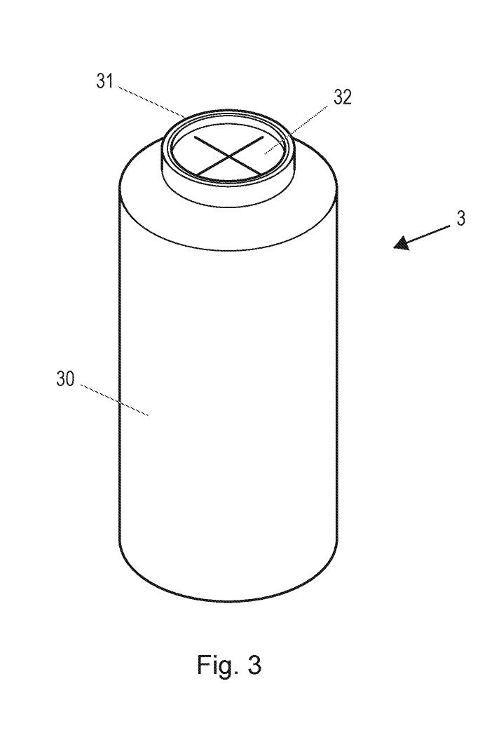

FIG. 3 shows an example of a refill bottle 3 for refilling an ink tank, e.g. the ink tank 1 of FIG. 1 or the ink tank 2 of FIG. 2. In the example the refill bottle 3 comprises a cylindrical main reservoir portion 30 having a first diameter, and a neck extending upwardly from the top of the main reservoir portion, where the neck is cylindrical having a second diameter smaller than the first diameter. The top of the neck terminates in an opening 31. In some examples the main reservoir portion 30 comprises a transparent material, to facilitate a determination of the amount of ink contained in the refill bottle 3. The opening 31 is to sealingly couple with an ink conduit and an air conduit of an ink tank. In some examples the opening comprises a flexible and resilient membrane to accommodate and seal against an object pushed into the opening. In the example shown in FIG. 3, the opening 31 comprises a rubber membrane 32 covering the full area of the opening 31.

A slit in the form of a cross is provided in the membrane, such that the membrane 32 comprises four abutting flaps. Other examples are envisaged in which a differently-shaped slit or opening is provided in the membrane 32, so as to create a different number of flaps. In some such examples a single linear slit is provided, in which case no flaps are created. When an object, e.g. the top end of the interface component 28 of the ink tank 2, is pushed into the opening 31, the flaps fold into the neck of the refill bottle 3 so as to permit entry of the object. Due to the flexibility and resilience of the membrane material, the flaps conform to the shape of the object and thereby create a seal against it.

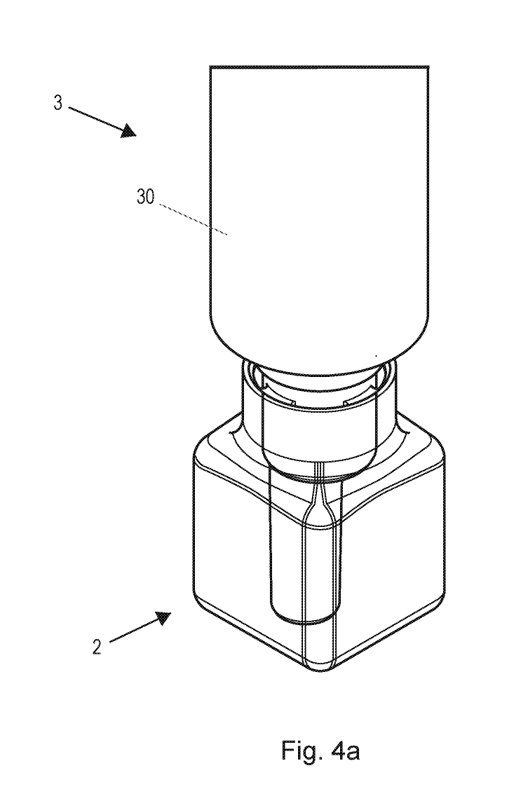

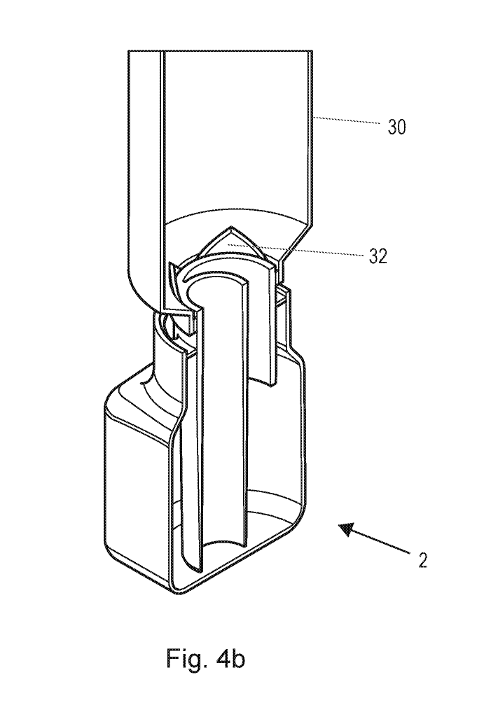

FIGS. 4a and 4b show the refill bottle 3 engaged with the ink tank 2 of FIG. 2. Together the ink tank 2 and the ink refill bottle 3 comprise an ink refill system. It can be seen that the shape of opening 31 of the refill bottle 3 is complementary to the shape of the combined cross-section of the ink conduit 20 and the air conduit 21 of the ink tank (i.e. both are circular, and the combined cross-section has a slightly smaller diameter than the opening) such that the ink conduit 20 and the air conduit 21 are receivable into the opening 31. It can also be seen that the flaps of the membrane 32 have been bent back inside the refill bottle 3 by the entry of the interface component 28 of the ink tank 2 into the opening 31 and are consequently creating a seal against the outer surface of the interface component 28. Furthermore, the outer diameter of the neck of the refill bottle 3 is less than the inner diameter of the seating ring 29 of the ink tank interface component 28. This ensures that the vent 24 is not blocked by the engagement of the refill bottle 3 with the ink tank 2. In other examples blocking of a vent can be prevented in other ways, such as providing the vent in a location away from the ink conduit and air conduit of an ink tank.

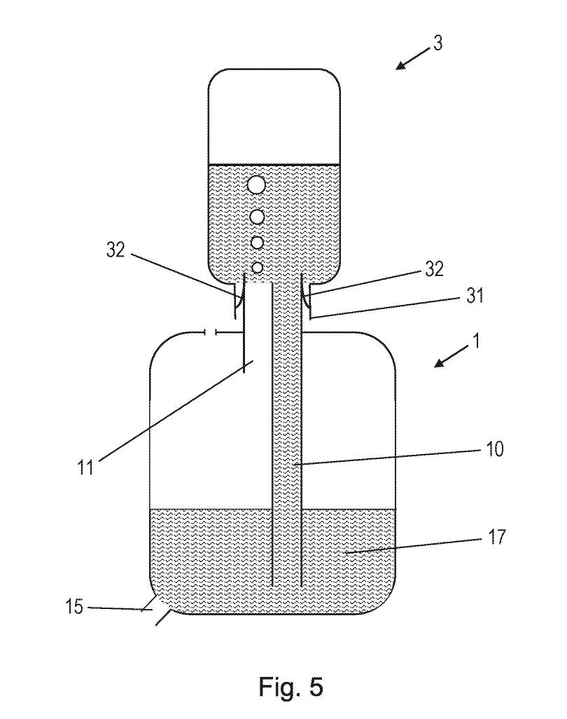

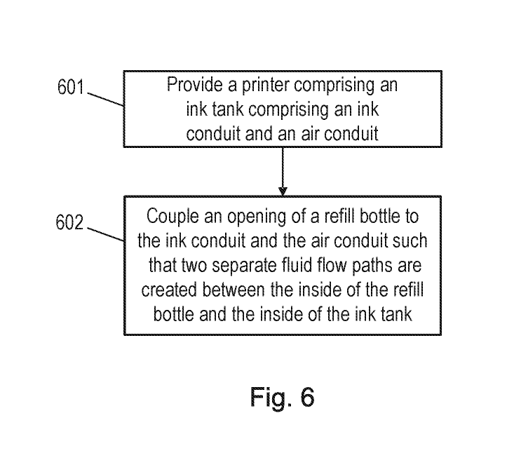

An example refilling operation of an ink tank, e.g. the ink tank 1, will now be described with reference to FIGS. 5 and 6. FIG. 5 shows the refill bottle 3 engaged with the ink tank 1 of FIG. 1 during an example of a refilling operation of the ink tank 1. FIG. 6 shows an example of a method of refilling operation an ink tank, e.g. the ink tank 1.

The method of FIG. 6 comprises providing a printer comprising an ink tank, block 601. The ink tank of the printer comprises an ink conduit connecting the inside of the tank to the outside of the tank and extending inside the tank from the top end by a first distance; and an air conduit connecting the inside of the tank to the outside of the tank and extending inside the tank from the top end by a second distance, the second distance being less than the first distance. The ink tank further comprises a vent connecting the inside of the tank to the outside of the tank, located at a third distance from the top end, the third distance being less than the second distance; and an ink outlet connecting the inside of the tank to the outside of the tank, located at a fourth distance from the top end, the fourth distance being greater than the second distance. In some examples the ink tank of the printer is an off-axis ink tank. In some examples the ink tank is an ink tank 1 as shown in FIG. 1. In some examples the ink tank is an ink tank 2 as shown in FIG. 2. In some examples the ink tank of the printer is empty. In some examples the ink tank of the printer is partially filled with ink.

In block 602 an opening of a refill bottle is coupled to the ink conduit and the air conduit of the ink tank of the printer such that that two separate fluid flow paths are created between the inside of the refill bottle and the inside of the ink tank. In some examples the refill bottle contains ink. In some examples the refill bottle is a refill bottle 3 as shown in FIG. 3. In some examples the performance of block 602 comprises accommodating the ink conduit and the air conduit of the ink tank within the opening of the refill bottle. In some examples the performance of block 602 comprises creating a seal between the opening of the refill bottle and the ink conduit and the air conduit of the ink tank. In some examples the performance of block 602 causes ink to flow from the refill bottle into the ink tank, e.g. because coupling the opening of the refill bottle to the ink conduit and air conduit of the ink tank involves positioning the opening of the refill bottle below a reservoir part of the refill bottle.

FIG. 5 illustrates the situation after the performance of block 602. It can be seen that ink 17 is flowing from the refill bottle 3, through the ink conduit 10, and into the ink tank 1. Simultaneously, air is flowing from the ink tank 1, through the air conduit 11, and into the refill bottle 3. As a result of these flows, the ink level in the ink tank 1 will rise until it meets the lower end of the air conduit 11. At this point the flow of air from the ink tank into the refill bottle 3 via the air conduit 11 will stop. Since air can no longer flow into the refill bottle to replace outgoing ink, the flow of ink from the refill bottle 3 into the ink tank 1 is also prevented by the blocking of the air conduit 11 by the ink 17. The examples thereby provide an automatic fill-level limiting mechanism. This means that a refill bottle can be left engaged with an ink tank even if the ink tank becomes full when the refill bottle is not yet empty.

Thus, some examples of the method of FIG. 6 comprise maintaining the opening of the refill bottle coupled to the air conduit and ink conduit of the ink tank until the refill bottle is empty.

In some such examples a printing operation of the printer is performed whilst the opening of the refill bottle is coupled to the air conduit and ink conduit of the ink tank. During a printing operation of the printer the ink 17 flows out of the ink outlet 15 to a print head of the printer and is deposited on a print medium. Therefore printing operations cause the level of ink in the ink tank 1 to drop. However; if a full or partially full refill bottle is engaged with the ink tank 1 during a printing operation, as the ink level in the ink tank drops below the lower end of the air conduit 11, ink is permitted to flow into the ink tank 1 from the refill bottle 3. As such, the ink level in the ink tank is maintained at or near the maximum fill level as set by the location of the bottom end of the air conduit 11.

In some such examples it can occur that the refill bottle becomes empty during a printing operation of the printer. When this occurs, ink 17 which flows out of the ink tank through the ink outlet 15 is not replaced by ink flowing in from the refill bottle 3. Instead, air is drawn into the ink tank 1 through the vent 14. This means that the back pressure does not change, and therefore that the printing operation is not affected.

In some examples the method is performed during a printing operation of the printer. In some examples a printing operation of the printer is performed during performance of the method.

The examples therefore enable refilling of an ink tank for a printer to be performed during operation of the printer. The examples also enable a refill bottle to be left engaged with the ink tank of a printer for as long as is necessary for the refill bottle to become empty, even if this does not occur until after several printing operations have been performed with the refill bottle engaged. As such, the risk of spillage or overflow of ink during a refilling operation is minimized.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfill the functions of several units recited in the claims.

The features of any dependent claim may be combined with the features of any of the independent claims or other dependent claims.

1. An ink tank for an inkjet printer, the ink tank having a top end and a bottom end and comprising:
an ink conduit connecting the inside of the tank to the outside of the tank, wherein the ink conduit extends inside the tank from the top end by a first distance;
an air conduit connecting the inside of the tank to the outside of the tank, wherein the air conduit extends inside the tank from the top end by a second distance, the second distance being less than the first distance;
a vent connecting the inside of the tank to the outside of the tank, an inside opening of the vent being located at a third distance from the top end, the third distance being less than the second distance; and
an ink outlet connecting the inside of the tank to the outside of the tank, an inside opening of the ink outlet being located at a fourth distance from the top end, the fourth distance being greater than the second distance.

2. The ink tank in accordance with claim 1, wherein the ink conduit and the air conduit are adjacent and have complementary cross-sectional shapes to create a regularly-shaped combined cross-section of the ink conduit and the air conduit.

3. The ink tank in accordance with claim 2, wherein the combined cross-section of the ink conduit and the air conduit is circular.

4. The ink tank in accordance with claim 1, wherein the ink conduit is formed integrally with the air conduit.

5. The ink tank in accordance with claim 1, comprising a pressure control device connecting the inside of the tank to the outside of the tank, an inside opening of the pressure control device being located at a fifth distance from the top end, the fifth distance being less than the first distance and greater than the second distance.

6. The ink tank in accordance with claim 5, wherein the fifth distance is effective to prevent a backpressure in the ink tank when the ink tank is in use on an inkjet printer from exceeding a predetermined maximum back pressure.

7. The ink tank in accordance with claim 1, wherein the second distance is effective to prevent an ink level in the ink tank when the ink tank is being filled via the ink conduit from increasing above a predetermined maximum level.

8. The ink tank in accordance with claim 1, wherein the second distance is effective to prevent a backpressure in the ink tank when the ink tank is in use on an inkjet printer from decreasing below a predetermined minimum pressure.

9. An ink refill system comprising:
an ink tank for an inkjet printer, the ink tank having a top end and a bottom end and comprising:
an ink conduit connecting the inside of the tank to the outside of the tank, wherein the ink conduit extends inside the tank from the top end by a first distance;
an air conduit connecting the inside of the tank to the outside of the tank, wherein the air conduit extends inside the tank from the top end by a second distance, the second distance being less than the first distance;
a vent connecting the inside of the tank to the outside of the tank, an inside opening of the vent being located at a third distance from the top end, the third distance being less than the second distance; and
an ink outlet connecting the inside of the tank to the outside of the tank, an inside opening of the ink outlet being located at a fourth distance from the top end, the fourth distance being greater than the second distance; and
a refill bottle, comprising an opening to sealingly couple with the ink conduit and the air conduit of the ink tank.

10. The ink refill system in accordance with claim 9, wherein the opening of the refill bottle comprises a flexible and resilient membrane to accommodate and seal against an object pushed into the opening.

11. The ink refill system in accordance with claim 9, wherein the shape of the opening of the refill bottle is complementary to the shape of the combined cross-section of the ink conduit and the air conduit of the ink tank, such that the ink conduit and the air conduit are receivable into the opening.

12. A refill bottle for an ink refill system in accordance with claim 9.

13. A printer comprising the ink tank in accordance with claim 1.

14. A method comprising:
providing a printer having a ink tank, wherein the ink tank has a top end and a bottom end and comprises:
an ink conduit connecting the inside of the tank to the outside of the tank, wherein the ink conduit extends inside the tank from the top end by a first distance;
an air conduit connecting the inside of the tank to the outside of the tank, wherein the air conduit extends inside the tank from the top end by a second distance, the second distance being less than the first distance;
a vent connecting the inside of the tank to the outside of the tank, an inside opening of the vent being located at a third distance from the top end, the third distance being less than the second distance; and
an ink outlet connecting the inside of the tank to the outside of the tank, an inside opening of the ink outlet being located at a fourth distance from the top end, the fourth distance being greater than the second distance; and
coupling an opening of a refill bottle to the ink conduit and the air conduit of the ink tank of the printer such that two separate fluid flow paths are created between the inside of the refill bottle and the inside of the ink tank.

15. The method in accordance with claim 14, wherein the method is performed during a printing operation of the printer.
